(19) United States
(12) Patent Application Publication
(10) Pub. No.: US 2006/0293889 A1
(43) Pub. Date: Dec. 28, 2006

(54) Error correction for speech recognition systems

(75) Inventors: Imre Kiss, Tampere (FI); Jussi Artturi Leppanen, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/169,277

(22) Filed: Jun. 27, 2005

(51) Int. Cl. G10L 15/26

(52) U.S. Cl. 704/235

(57) ABSTRACT

Words in a sequence of words that is obtained from speech recognition of an input speech sequence are presented to a user, and at least one of the words in the sequence of words is replaced, in case it has been selected by a user for correction. Words with a low recognition confidence value are emphasized; alternative word candidates for the at least one selected word are ordered according to an ordering criterion; after replacing a word, an order of alternative word candidates for neighboring words in the sequence is updated; the replacement word is derived from a spoken representation of the at least one selected word by speech recognition with a limited vocabulary; and the word that replaces the at least one selected word is derived from a spoken and spelled representation of the at least one selected word.

### FIELD OF THE INVENTION

This invention relates to methods, devices and software application products for correcting words in a sequence of words that is obtained from speech recognition of an input speech sequence.

### BACKGROUND OF THE INVENTION

Basic speech recognition techniques are known from desktop applications and are also starting to emerge in the field of personal mobile communications. An example of speech recognition in a mobile terminal is name dialing, where a user simply speaks the name of the person that shall be called, and the mobile terminal then performs speech recognition to automatically determine the name, look up the corresponding number from the mobile terminal's address book and launch the call.

It is expected that the implementation of more advanced speech recognition applications will become feasible in future mobile terminal platforms, as processing power and memory are continuously becoming cheaper. Backed up by the increased processing power and memory, such advanced speech recognition applications can then achieve a performance that is acceptable for mobile users.

An example of an advanced speech recognition application is mobile dictation. In mobile dictation, a user can input longer stretches of text (such as an email or SMS) into a mobile terminal that may provide only a small-size keyboard or no keyboard at all. A high-performance mobile dictation system may thus significantly increase the speed and ease of text input.

The downside encountered in mobile dictation is that the average speech recognition accuracy of continuous speech is currently in the range of 60% to 95% at the word level, depending on the language, speaking style, ambient noise and size of the dictation domain. The best performance is achieved by limiting the dictation domain (e.g. by limiting the vocabulary that has to be understood by the speech recognizer), resulting in a comparatively small and accurate language model, and by using the mobile terminal in a clean (non-noisy) environment.

With speech recognition still being imperfect, error correction is indispensable even in advanced speech recognition applications in order to be acceptable for the user. This error correction has to be efficient and fast, because otherwise, the time advantage gained by inputting texts via speech recognition are outweighed by the time required to correct the errors.

U.S. patent application US 2002/0138265 A1 reviews and proposes techniques to correct errors occurring in a continuous speech recognition system. Therein, a processor determines what a user said by finding acoustic models that best match the digital frames of an utterance, and identifying text that corresponds to those acoustic models. An acoustic model may correspond to a word, phrase or command from a vocabulary. An acoustic model also may represent a sound, or phoneme, that corresponds to a portion of a word. Collectively, the constituent phonemes for a word represent the phonetic spelling of the word. Acoustic models also may represent silence and various types of environmental noise. The words or phrases corresponding to the best matching acoustic models are referred to as recognition candidates. The processor may produce a single recognition candidate for an utterance, or may produce a list of recognition candidates. Correction mechanisms reviewed in US 2002/0138265 A1 comprise displaying a list of choices for each recognized word and permitting a user to correct a misrecognition by selecting a word from the list or typing the correct word. According to one prior art speech recognition system reviewed by US 2002/0138265 A1, a list of numbered recognition candidates is displayed for each word spoken by a user, and the best-scoring recognition candidate is inserted into the text dictated by a user. If the best-scoring recognition candidate is incorrect, the user can select a recognition candidate from the list by saying “choose-N”, where “N” is the number associated with the correct candidate. If the correct word is not on the choice list, the user can refine the list, either by typing in the first letters of the correct word, or by speaking the words (for example “alpha”, “bravo”) associated with the first few letters. If the user notices a recognition error after dictating additional words, the user can say “Oops”, which brings up a numbered list of previously-recognized words. The user can then choose a previously-recognized word by saying “word-N”, where “N” is a number associated with the word. The system then responds by displaying a list associated with the selected word and permitting the user to correct the word as described above.

### SUMMARY OF THE INVENTION

Setting out from this prior art, it is, inter alia, an object of the present invention to propose improved methods, devices and software application products for error correction in speech recognition systems.

According to a first aspect of the present invention, a method is proposed for correcting words in a sequence of words that is obtained from speech recognition of an input speech sequence. Said method comprises presenting said sequence of words to a user, wherein each word in said sequence of words is associated with a respective recognition confidence value, and wherein at least one word in said sequence of words is automatically emphasized in dependence on its recognition confidence value; and replacing at least one word in said sequence of words, in case it has been selected by a user for correction.

Said input speech sequence is a spoken representation of one or more words, for instance a complete sentence, that may for instance be recorded by a microphone or retrieved from a memory. Speech recognition is performed on said input speech sequence to obtain said sequence of words, wherein it is desired that said words in said sequence of words match the words that are contained as spoken representation in said input speech sequence. Mismatches are considered as errors, which are desired to be corrected before said sequence of words is further processed (for instance stored in a memory or transmitted as a message to a receiver). Each of said words in said sequence of words is associated with a recognition confidence value, representing a confidence that said word was recognized from said input speech sequence correctly. Said recognition confidence level may for instance be determined by a speech recognizer during speech recognition, but may equally well be determined in a post-processing stage. Said recognition confidence value may also be based on information of said speech recognizer and information from said post-processing stage. As a simple example, said recognition confidence may correspond to an acoustic score being assigned by a speech recognizer to each word.

To correct errors (i.e. misrecognized words), said sequence of words is presented to a user, wherein said user may for instance be the user that spoke said input speech sequence. Equally well, said input speech sequence may have been provided by a first user, and then may be proofread by a second user. Said presentation may for instance be performed optically, for instance by displaying said sequence of words to said user via a display, or acoustically, for instance by performing text-to-speech conversion of said sequence of words and playing the converted speech via a loudspeaker.

In said presentation of said sequence of words, at least one word of said sequence of words is emphasized in dependence on its recognition confidence value. For instance, words in said sequence of words which are associated with a particularly low recognition confidence value (and a correspondingly high potential error probability) may be emphasized to assist a user in finding errors more quickly or to facilitate their selection for error correction. In contrast to prior art error correction techniques, thus a faster and more efficient error correction can be achieved. Therein, the way of emphasizing depends on the way said sequence of words is presented. For instance, if said sequence of words is displayed on a display, said emphasizing may be performed by changing an appearance of said at least one word that is to be emphasized, for instance by highlighting said at least one word or changing its font, color or style.

If at least one word of said sequence of words is selected by said user, said at least one word is replaced. Said replacement may be performed based on user interaction, or automatically. For instance, said user may provide a replacement word for said at least one selected word by typing in said replacement word, or by (again) inputting a spoken representation of said word in order to allow word-level based speech recognition of said spoken representation, or by selecting a replacement word from a list of word candidates that is offered to the user.

In an embodiment of the method according to the first aspect of the present invention, said at least one emphasized word is associated with the lowest recognition confidence value of all words in said sequence of words. Said user's attention is then drawn to that word in said sequence of words that has the highest probability of erroneous recognition. The user may then check said word for correctness and, if said word is found to be incorrect, take action to correct said word. By emphasizing only one single word, an overflowing of the user with information may be avoided when presenting said sequence of words.

According to this embodiment, said at least one emphasized word may be automatically emphasized by automatically positioning a selector on it. Said selector may for instance be a pointer or cursor that can be controlled by said user to select words in said presented sequence of words for correction. Automatically placing said selector on said at least one word with the lowest recognition confidence then serves a double purpose. On the one hand, said user's attention is drawn to said word, which has a high probability of being erroneously recognized. On the other hand, no selector movements by said user are required to select said word for correction in case said word is found to be incorrect by said user. For instance, only a confirmation of the automatic selection of said word then may be required by the user to start an error correction process.

In a further embodiment of the method according to the first aspect of the present invention, said at least one emphasized word is associated with a recognition confidence value that is below a pre-defined threshold. Said threshold may for instance be a default threshold, or may be defined or altered by said user. Instead of emphasizing only the word with the associated lowest recognition confidence value, all words with an associated recognition value being lower than said pre-defined threshold are emphasized. A user then can be sure that all emphasized words in said sequence of words are likely to contain errors and thus should be checked carefully.

According to the first aspect of the present invention, furthermore a device for correcting words in a sequence of words that is obtained from speech recognition of an input speech sequence is proposed. Said device comprises means arranged for presenting said sequence of words to a user, wherein each word in said sequence of words is associated with a respective recognition confidence value, and wherein at least one word in said sequence of words is automatically emphasized in dependence on its recognition confidence value; and means arranged for replacing at least one word in said sequence of words, in case it has been selected by a user for correction. Said means arranged for presenting said sequence of words may for instance be a display with associated display logic or a loudspeaker with associated sound logic. Said means arranged for presenting said sequence of words then may also contain means arranged for emphasizing said at least one word. Said means arranged for replacing said at least one word may for instance comprise a user interface for interacting with a user, for instance to allow said user to select a replacement word for said at least one selected word from a list or to input a spoken representation of said at least one word to allow for a new speech recognition or to type in said at least one word.

In an embodiment of the device according to the first aspect of the present invention, said device is a portable multimedia device or a part thereof. Said device may for instance be a mobile phone, a personal digital assistant, a computer, a digital dictation device or similar. Alternatively, said device may also be a desktop computer or a part thereof.

According to the first aspect of the present invention, furthermore a software application product is proposed, comprising a storage medium having a software application for correcting words in a sequence of words that is obtained from speech recognition of an input speech sequence embodied therein. Said software application comprises program code for presenting said sequence of words to a user, wherein each word in said sequence of words is associated with a respective recognition confidence value, and wherein at least one word in said sequence of words is automatically emphasized in dependence on its recognition confidence value; and program code for replacing at least one word in said sequence of words, in case it has been selected by a user for correction.

Said storage medium may be any volatile or non-volatile memory or storage element, such as for instance a Read-Only Memory (ROM), Random Access Memory (RAM), a memory stick or card, and an optically, electrically or magnetically readable disc. Said program code comprised in said software application may be implemented in a high level procedural or object oriented programming language to communicate with a computer system, or in assembly or machine language to communicate with a digital processor. In any case, said program code may be a compiled or interpreted code.

According to a second aspect of the present invention, a method is proposed for correcting words in a sequence of words that is obtained from speech recognition of an input speech sequence, wherein for each word in said sequence of words, an associated set of alternative word candidates exists. Said method comprises presenting said sequence of words to a user, and replacing at least one word in said sequence of words, in case it has been selected by said user for correction, by a word candidate from its associated set of word candidates, wherein said word candidates in said set of word candidates that is associated with said at least one selected word are ordered according to an ordering criterion related to a likelihood of said word candidates to correctly replace said at least one selected word.

For each of said words in said sequence of words, a set of word candidates exists. Therein, different sets of word candidates may contain the same number of word candidates, or different numbers of word candidates. Said word candidates may for instance be determined by a speech recognizer during said speech recognition. For instance, a speech recognizer may obtain said input speech sequence, which is a spoken representation of one or more words, and perform speech recognition on segments of said input speech sequence in order to determine said one or more words that are represented by said input speech sequence. For each of said segments of said input speech segment, which are assumed by said speech recognizer to represent a respective word, said speech recognizer may then produce a plurality of possible recognition results, wherein, for instance, the most probable recognition result is output as said respective word, and the remaining recognition results (or a sub-set thereof) are output as said respective set of word candidates associated with said respective word.

To allow a user to proofread the result of speech recognition, said sequence of words obtained from said speech recognition is presented to said user. Said user then may select at least one word from said sequence of words, if he considers said at least one selected word to be erroneously recognized. In response to said selection, said at least one selected word is replaced by a word candidate from the set of word candidates that is associated with said at least one selected word. Said replacement may be performed automatically or based on user interaction. According to the second aspect of the present invention, and in contrast to prior art error correction techniques, the word candidates in at least said set of word candidates that is related to said at least one selected word are ordered according to an ordering criterion that is related to a likelihood of said word candidates to correctly replace said at least one selected word. This may significantly speed up the selection of word candidates from said set of word candidates. For instance, if said word candidates are ordered with decreasing likelihood to correctly replace said at least one selected word, and if said set of word candidates is presented to said user in the form of a list (for instance as a scroll-down list), said user may only have to consider the first entries in the list until he finds the correct replacement for said at least one selected word. Furthermore, if said user has to move a selector through said list to select the word candidate that shall replace said at least one selected word, also the number of required selector movement steps can be minimized, which makes error correction fast and more efficient. Said ordering of said word candidates in said set of word candidates may for instance be performed only for said set of word candidates that is associated with said at least one selected word, for instance after said selection of said at least one word. This may save some computational complexity required for sorting. Alternatively, said ordering of said word candidates may be performed for all sets of word candidates, for instance during or after speech recognition. Then sorting does not have to be performed after said selection of said at least one word for correction, which may speed up the actual error correction process.

In an embodiment of the method according to the second aspect of the present invention, said ordering criterion is based on at least one of a language model that contains statistics on the likelihood of a set of words comprising at least one word to occur in a language, and a recognition confidence of said word candidates, wherein said recognition confidence expresses, for each word candidate in a set of word candidates, a respective confidence that said word candidate is a correct speech recognition result.

Said language model may for instance be a uni-gram model, which expresses a likelihood of a single word to occur (or be used) in a language. This likelihood may be expressed in the form of a language model score, wherein rare words have lower scores. Equally well, said language model may be a bi-gram model, that considers the likelihood of a set of words comprising two words to occur in a language (or, in other words, the likelihood of two words of a language to follow each other). Also statistics on sets of words comprising three or more words may be considered (e.g. a tri-gram model, etc.). If said ordering criterion is based on said bi-gram language model, a previous word and/or a next word in said sequence of words may be considered when ordering the word candidates in a set of word candidates that is associated with a word that is between said previous word and said next word.

If said ordering criterion is based on said recognition confidence, recognition confidence values, as for instance determined by a speech recognizer for each word candidate in a set of word candidates, are considered when ordering the word candidates in said sets of word candidates.

Said ordering criterion may also be based on both said language model and said recognition confidence, for instance by assigning each word candidate a language model score and a recognition confidence value and combining both metrics into a combined score that is considered in said ordering of said word candidates.

In a further embodiment of the method according to the second aspect of the present invention, a selecting of said word candidate that replaces said at least one selected word from said set of word candidates comprises stepping through said word candidates on a word-candidate-by-word-candidate basis.

Said set of word candidates may for instance be presented to the user in a list (e.g. a scroll-down list), and said stepping may for instance be performed by a joystick, or by arrow keys of a keyboard, wherein each movement of said joystick (e.g. scrolling by one entry of said list) or each stroke on the arrow keys moves a selector forward or backward by one entire word candidate. Apparently, ordering said word candidates, for instance with decreasing probability to correctly replace said at least one selected word, according to the second aspect of the present invention then contributes to reducing the number of steps required in said selecting of said replacing word candidate, as the word candidates that most probably replace said at least one selected word are arranged at the beginning of said list, where also the selector may be initially positioned.

In a further embodiment of the method according to the second aspect of the present invention, said ordering criterion is at least based on a language model that contains statistics on the likelihood of at least two words of a language following each other, and said method further comprises updating, in case said at least one word has been selected and replaced in said sequence of words by said word candidate, an order of word candidates in at least one set of word candidates associated with a respective word that is, within said sequence of words, adjacent to said at least one selected and replaced word, wherein said updating of said order of said word candidates in said at least one set of word candidates is performed according to said ordering criterion and under consideration of said word candidate by which said at least one selected and replaced word has been replaced.

Therein, said ordering criterion may be solely based on said language model, which may for instance be a bi-gram language model, or may be based on further information, such as for instance a recognition confidence of word candidates, as well. When a selected word is replaced by a word candidate from the set of word candidates that is associated with said selected word, the ordering of a set of word candidates associated with a previous word and/or a next word in said sequence of words is updated according to said ordering criterion. As the order of said word candidates in said sets of word candidates associated with said previous and next words depends on said selected and replaced word due to the dependence of said ordering criterion on said language model (e.g. a bi-gram language model), updating said sets of word candidates improves the quality of the order in said sets of word candidates and thus contributes to make the error correction according to the present invention faster and more efficient. A case that the order of word candidates in only one set of word candidates requires updating may occur if said sequence of words only comprises two words, one of which is selected and replaced. Furthermore, when assuming that words are selected by a user for correction one after the other, for instance starting from the beginning of said sequence of words, it may be sufficient to update only the order of word candidates of sets of word candidates that are associated with words that are right neighbors of selected and replaced words. This may significantly reduce sorting overhead.

According to the second aspect of the present invention, furthermore a device for correcting words in a sequence of words that is obtained from speech recognition of an input speech sequence is proposed, wherein for each word in said sequence of words, an associated set of alternative word candidates exists. Said device comprises means arranged for presenting said sequence of words to a user; and means arranged for replacing at least one word in said sequence of words, in case it has been selected by said user for correction, by a word candidate from its associated set of word candidates, wherein said word candidates in said set of word candidates that is associated with said at least one selected word are ordered according to an ordering criterion related to a likelihood of said word candidates to correctly replace said at least one selected word.

An embodiment of the device according to the second aspect of the present invention further comprises means arranged for stepping through selection alternatives on a word-candidate-by-word-candidate basis in order to select said word candidate that replaces said at least one selected word from said set of word candidates. Said means may for instance comprise a joystick or keypad.

A further embodiment of the device according to the second aspect of the present invention comprises means arranged for updating, in case said at least one word has been selected and replaced in said sequence of words by said word candidate, an order of word candidates in at least one set of word candidates associated with a respective word that is, within said sequence of words, adjacent to said at least one selected and replaced word, wherein said ordering criterion is at least based on a language model that contains statistics on the likelihood of at least two words of a language following each other, and wherein said updating of said order of said word candidates in said at least one set of word candidates is performed according to said ordering criterion and under consideration of said word candidate by which said at least one selected and replaced word has been replaced.

A further embodiment of the device according to the second aspect of the present invention is a portable multimedia device or a part thereof.

According to the second aspect of the present invention, further a software application product is proposed, comprising a storage medium having a software application embodied therein for correcting words in a sequence of words that is obtained from speech recognition of an input speech sequence, wherein for each word in said sequence of words, an associated set of alternative word candidates exists. Said software application comprises program code for presenting said sequence of words to a user, and program code for replacing at least one word in said sequence of words, in case it has been selected by said user for correction, by a word candidate from its associated set of word candidates, wherein said word candidates in said set of word candidates that is associated with said at least one selected word are ordered according to an ordering criterion related to a likelihood of said word candidates to correctly replace said at least one selected word.

In an embodiment of the software application product according to the second aspect of the present invention, said ordering criterion is at least based on a language model that contains statistics on the likelihood of at least two words of a language following each other, and said software application product further comprises program code for updating, in case said at least one word has been selected and replaced in said sequence of words by said word candidate, an order of word candidates in at least one set of word candidates associated with a respective word that is, within said sequence of words, adjacent to said at least one selected and replaced word, wherein said updating of said order of said word candidates in said at least one set of word candidates is performed according to said ordering criterion and under consideration of said word candidate by which said at least one selected and replaced word has been replaced.

According to a third aspect of the present invention, a method is proposed for correcting words in a sequence of words that is obtained from speech recognition of an input speech sequence, wherein for each word in said sequence of words, an associated set of alternative word candidates exists. Said method comprises presenting said sequence of words to a user; and replacing at least one word in said sequence of words, in case it has been selected by said user for correction, by a word that is obtained from speech recognition of a new input speech sequence that only contains a representation of a correct version of said at least one selected word spoken by said user, wherein a recognition vocabulary used in said speech recognition of said new input speech sequence is limited to said set of word candidates associated with said at least one selected word.

Thus if an initial speech recognition, which is based on said input speech sequence and a specific recognition vocabulary (representing the set of words that speech recognition takes into account as possible results of speech recognition), leads to an incorrect recognition of said at least one selected word, error correction is performed by repeating speech recognition based on a new speech input sequence that contains only said spoken representation of said correct version of said at least one selected word and based on a restricted recognition vocabulary, which only comprises the word candidates from said set of word candidates that is associated with said at least one selected word. This may be beneficial in cases when there are significant acoustical differences between said word candidates and only insignificant differences between said word candidates from a language model point of view. In contrast to the large recognition vocabularies typically used in prior art error correction approaches, said reduced recognition vocabulary makes speech recognition according to the third aspect of the present invention less complex, and, correspondingly, also faster and more reliable.

According to the third aspect of the present invention, further a device is proposed for correcting words in a sequence of words that is obtained from speech recognition of an input speech sequence, wherein for each word in said sequence of words, an associated set of alternative word candidates exists. Said device comprises means arranged for presenting said sequence of words to a user; and means arranged for replacing at least one word in said sequence of words, in case it has been selected by said user for correction, by a word that is obtained from speech recognition of a new input speech sequence that only contains a representation of a correct version of said at least one selected word spoken by said user, wherein a recognition vocabulary used in said speech recognition of said new input speech sequence is limited to said set of word candidates associated with said at least one selected word.

An embodiment of the device according to the third aspect of the present invention is a portable multimedia device or a part thereof.

According to the third aspect of the present invention, further a software application product is proposed, comprising a storage medium having a software application embodied therein for correcting words in a sequence of words that is obtained from speech recognition of an input speech sequence, wherein for each word in said sequence of words, an associated set of alternative word candidates exists. Said software application comprises program code for presenting said sequence of words to a user; and program code for replacing at least one word in said sequence of words, in case it has been selected by said user for correction, by a word that is obtained from speech recognition of a new input speech sequence that only contains a representation of a correct version of said at least one selected word spoken by said user, wherein a recognition vocabulary used in said speech recognition of said new input speech sequence is limited to said set of word candidates associated with said at least one selected word.

According to a fourth aspect of the present invention, a method is proposed for correcting words in a sequence of words that is obtained from speech recognition of an input speech sequence. Said method comprises presenting said sequence of words to a user; and replacing at least one word in said sequence of words, in case it has been selected by said user for correction, by a word that is obtained from a new input speech sequence, which only contains a representation of a correct version of said at least one selected word spoken by said user and a representation of said correct version of said at least one selected word spelled by said user.

If an initial speech recognition based on an initial input speech sequence produces a sequence of words that contains at least one erroneous word, according to the fourth aspect of the present invention, said at least one word can be selected by a user, and then speech recognition is repeated for said at least one selected word based on a new input speech sequence that only contains a spoken representation of a correct version of said at least one selected word and a spelled representation thereof (as for instance the new input speech sequence “Memphis, M E M P H I S”). Speech recognition then has to recognize both the spoken representation of the correct version of said at least one selected word, and the spoken representations of the letters that constitute the spelling of said correct version of said at least one selected word. Both representations may then be jointly processed by speech recognition to perform correct recognition of said correct version of said at least one selected word. The use of spelling may be particularly advantageous for the recognition of names or other rare words that are not contained in the recognition vocabulary that is used by speech recognition.

According to the fourth aspect of the present invention, further a device is proposed for correcting words in a sequence of words that is obtained from speech recognition of an input speech sequence. Said device comprises means arranged for presenting said sequence of words to a user; and means arranged for replacing at least one word in said sequence of words, in case it has been selected by said user for correction, by a word that is obtained from a new input speech sequence, which only contains a representation of a correct version of said at least one selected word completely spoken by said user and a representation of said correct version of said at least one selected word spelled by said user.

An embodiment of the device according to the fourth aspect of the present invention is a portable multimedia device or a part thereof.

According to the fourth aspect of the present invention, further a software application product is proposed, comprising a storage medium having a software application embodied therein for correcting words in a sequence of words that is obtained from speech recognition of an input speech sequence. Said software application comprises program code for presenting said sequence of words to a user; and program code for replacing at least one word in said sequence of words, in case it has been selected by said user for correction, by a word that is obtained from a new input speech sequence, which only contains a representation of a correct version of said at least one selected word spoken by said user and a representation of said correct version of said at least one selected word spelled by said user. These and other aspects of the invention will be apparent from and elucidated with reference to the embodiments described hereinafter.

### BRIEF DESCRIPTION OF THE FIGURES

In the figures show:

FIG. 1: A schematic presentation of the physical components of a device for error correction in speech recognition according to the present invention;

FIG. 2a: a block diagram illustrating the functionality of a speech recognition unit with improved error correction capabilities according to a first aspect of the present invention;

FIG. 2b: a block diagram illustrating the functionality of a speech recognition unit with improved error correction capabilities according to a second aspect of the present invention;

FIG. 2c: a block diagram illustrating the functionality of a speech recognition unit with improved error correction capabilities according to a third aspect of the present invention;

FIG. 2d: a block diagram illustrating the functionality of a speech recognition unit with improved error correction capabilities according to a fourth aspect of the present invention;

FIG. 3a: a flowchart of the steps performed by a method for error correction in speech recognition according to a first aspect of the present invention;

FIG. 3b: a flowchart of the steps performed by a method for error correction in speech recognition according to a second aspect of the present invention;

FIG. 3c: a flowchart of the steps performed by a method for error correction in speech recognition according to a third aspect of the present invention;

FIG. 3d: a flowchart of the steps performed by a method for error correction in speech recognition according to a fourth aspect of the present invention;

FIG. 4: an illustration of a sequence of words with an emphasized word according to the first aspect of the present invention;

FIG. 5: an illustration of a sequence of words with two emphasized words according to the first aspect of the present invention;

FIG. 6: an illustration of a sequence of words and a sorted set of word candidates according to the second aspect of the present invention; and

FIG. 7: an illustration of the updating of the order of word candidates in sets of word candidates in response to a word replacement in a sequence of words according to the second aspect of the present invention.

### DETAILED DESCRIPTION OF THE INVENTION

In the sequel of this detailed description of the present invention, the invention will be described by means of exemplary embodiments. Therein, without intending to limit the scope of applicability, deployment of the proposed techniques for error correction in speech recognition in the context of mobile dictation will exemplarily be assumed.

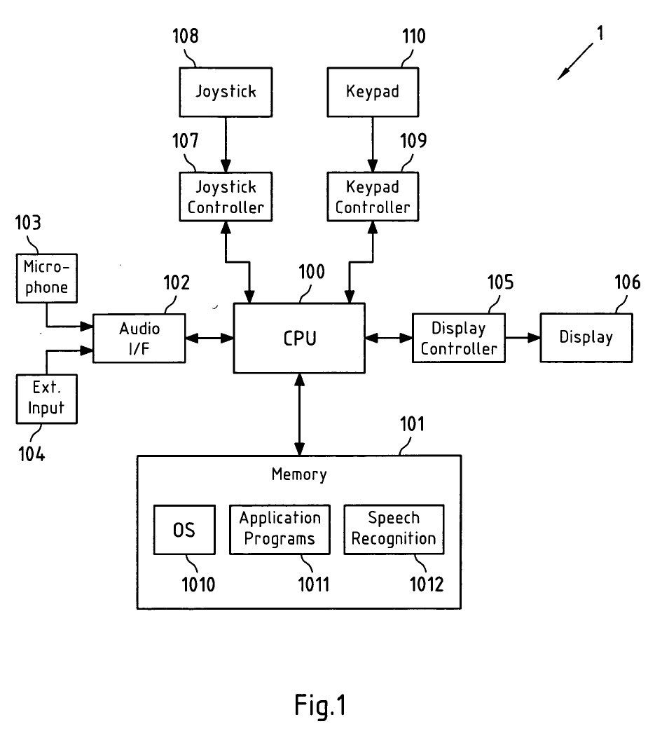

FIG. 1 depicts a device 1 for error correction in speech recognition according to the present invention. This device 1 is capable of implementing functionality to perform error correction according to each of the four proposed aspects of the present invention, or of any combination thereof.

Device 1 comprises a Central Processing Unit (CPU) 100, which controls the operation of the entire device 1. Said device 1 interacts with a memory 101, which comprises, among others, software code related to the Operating System (OS) 1010 of the device, application program code 1011 that can be executed by CPU 100 to provide specific functionalities to a user of said device, such as for instance mobile dictation and according error correction, and software code 1012 related to a speech recognition functionality. The device 1 further comprises an audio interface (I/F) 102 to receive input speech sequences, which may for instance be recorded by microphone 103 or received from external input 104 (such as for instance input speech sequences that are recorded in an external device and then are transferred to device 1). Device 1 further comprises a display controller 105 for controlling the operation of a display 106, which may for instance be a Liquid Crystal Display (LCD) or similar. Display 106 serves as an optical user interface of device 1 and allows for example to present sequences of words and sets of word candidates to a user of device 1. Device 1 further comprises a joystick controller 107 for receiving input from joystick 108, and a keypad controller 109 to receive input from a keypad 110. It is readily understood that the use of a joystick is of exemplary nature only. Equally well, a track ball, or arrow keys may be used to implement its functionality. Furthermore, due to the ability to perform speech recognition, device 1 may completely dispense with a keypad 110 altogether. Audio I/F 102, joystick controller 107, keypad controller 109 and display controller 105 are controlled by CPU 100 according to the OS 1010 and/or the application program 1011 CPU 100 is currently executing.

### FIRST ASPECT OF THE INVENTION

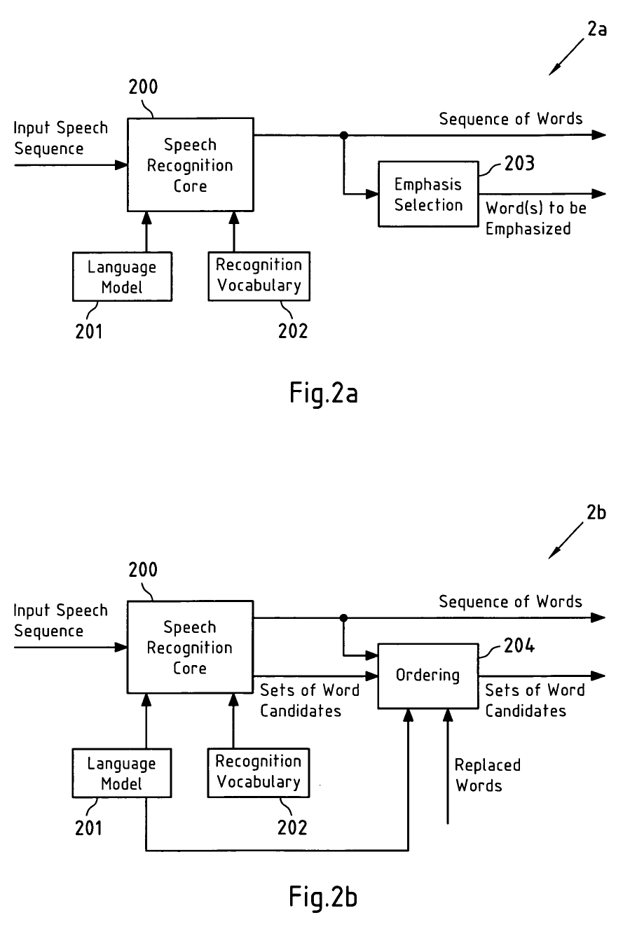

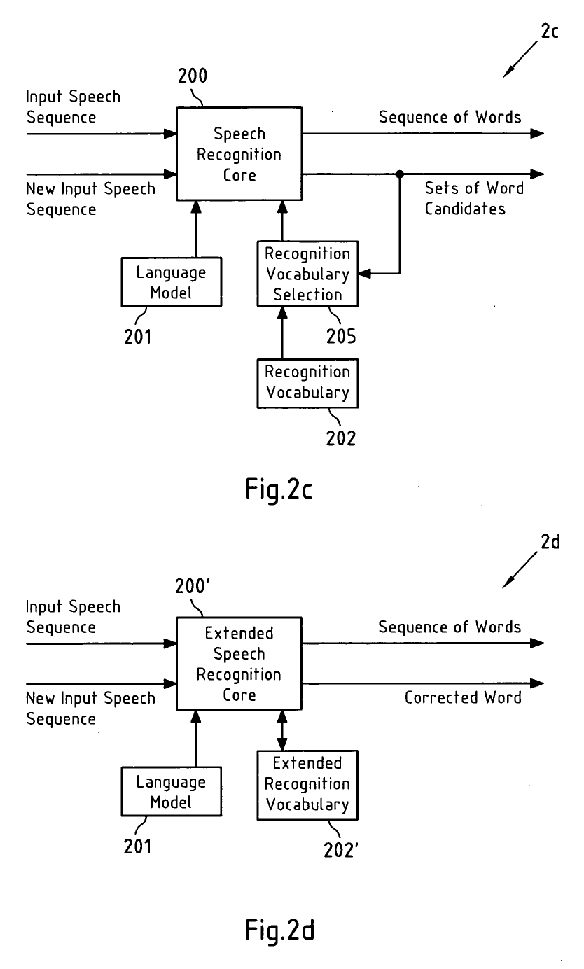

FIG. 2a schematically illustrates a block diagram illustrating the functionality of a speech recognition unit 2a with improved error correction capabilities according to a first aspect of the present invention. Therein, speech recognition core 200 of speech recognition instance 2a is implemented by CPU 100 of device. 1 (see FIG. 1) by executing speech recognition software 1012 stored in memory 101, and the emphasis selection unit 203 of speech recognition unit 2a is implemented by CPU 100 by executing an application program 1011 stored in memory 101. Speech recognition core 200 is capable of receiving an input speech sequence, which is a spoken representation of one or more words (for instance a complete sentence), and to perform speech recognition on said input speech sequence to determine a sequence of words that, in the optimal case, resembles said one or more words said input speech sequence is a representation of. To this end, speech recognition core 200 uses a language model 201 and a recognition vocabulary 202. Said language model 201 may for instance be stored in memory 101 of device 1 (see FIG. 1) and may comprise statistics on the probability of a set of words comprising at least one word to occur in a language. This may for instance be a uni-gram language model that is related to the likelihood of a single word to be used in a language, or a bi-gram language model that expresses a likelihood of two words of a language following each other. Also language models considering a larger number of subsequent words may be deployed (e.g. a tri-gram language model, etc.). Said recognition vocabulary 202 comprises the words said speech recognition core 200 is capable of detecting, and may also be stored in said memory 101 of device 1 (see FIG. 1).

Speech recognition core 200 may for instance perform speech recognition by segmenting said input speech sequence into segments that are assumed to relate to single words, and then attempts to recognize said single words, for instance by attempting to identify phonemes in said input speech sequence segments and to compare said phonemes to a phoneme-to-text mapping that may be comprised in said recognition vocabulary 202. Said speech recognition core 200 generally identifies a plurality of possible recognition results for each input speech sequence segment, and each of said possible recognition results is associated with a recognition confidence value that expresses a confidence of speech recognition core 200 that said recognition result is correct. For each input speech segment, speech recognition core 200 then may output the recognition result (a word) with the largest recognition confidence value, yielding a sequence of words that is considered to represent the input speech sequence. Speech recognition of speech recognition core 200 may be further refined by taking language model 201 into account. Then, in addition to the recognition confidence values, a probability that a set of one or more words occurs in a language is taken into account when determining which of the possible recognition results for each input speech sequence segment is output by speech recognition core 200 as the recognition result. Thus, in case of a bi-gram language model, even when a possible recognition result has a high confidence with respect to the acoustic space, e.g. “free” as opposed to “three”, due to the bi-gram language model, the speech recognition core 200 may nevertheless decide for “three”, since it knows the context, for instance “at” and “o'clock” in the intended sequence of words “at three o'clock”. Although the language model reduces the number of possible recognition results, the produced transcription may still contain errors. Error correction is thus indispensable. To this end, the sequence of words as output by speech recognition core 200 is then presented to a user. According to the first aspect of the present invention, not only said sequence of words is output by speech recognition unit 2a, but also information on at least one of said words in said sequence of words, which at least one word shall be emphasized during said presentation. Said emphasized word may for instance be a word that has the smallest recognition confidence value among all words in said sequence of words, and thus, among those words, has the highest probability of being incorrectly recognized. Equally well, it may be advantageous to emphasize all words in said sequence of words that have a recognition confidence value that is below a pre-defined threshold. To this end, speech recognition unit 2a is furnished with an emphasis selection instance 203, which receives the sequence of words as an input, wherein it is assumed that for each of said words in said sequence of words, the associated recognition confidence value is available for said emphasis selection instance 203. Based on these recognition confidence values, emphasis selection instance 203 then determines the words in said sequence of words that shall be emphasized and outputs this information, for instance to a presentation unit.

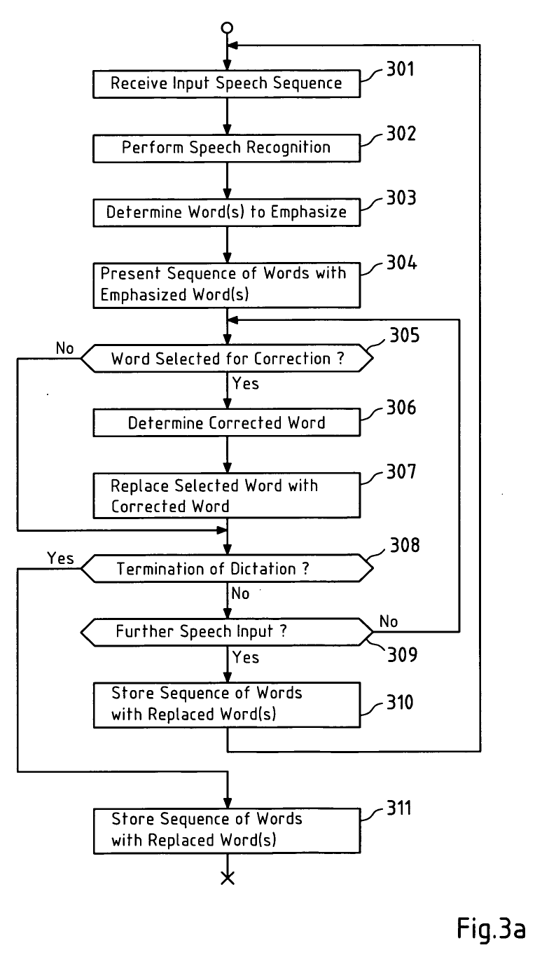

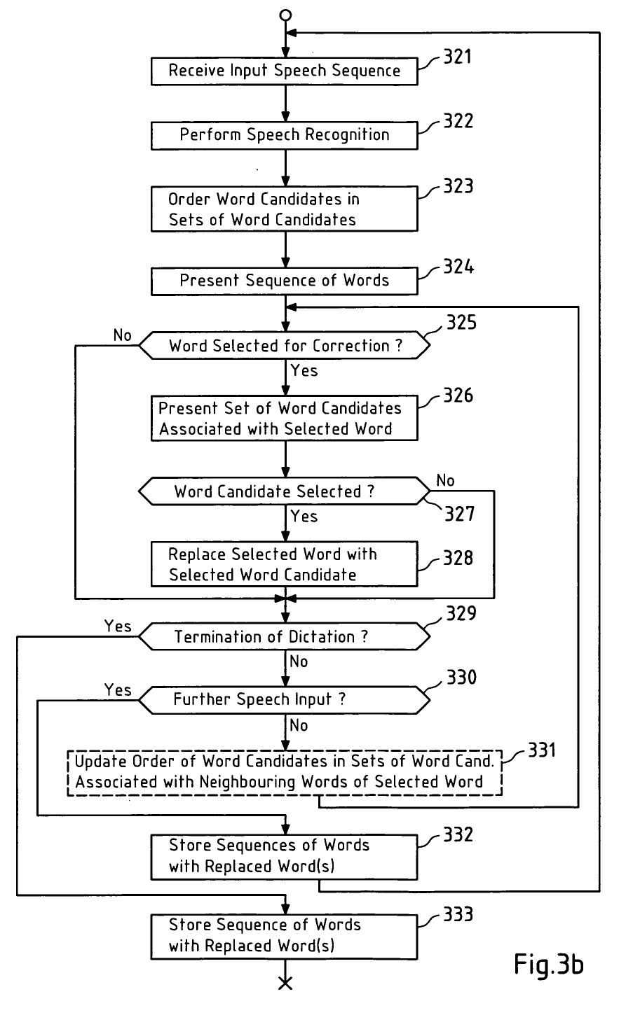

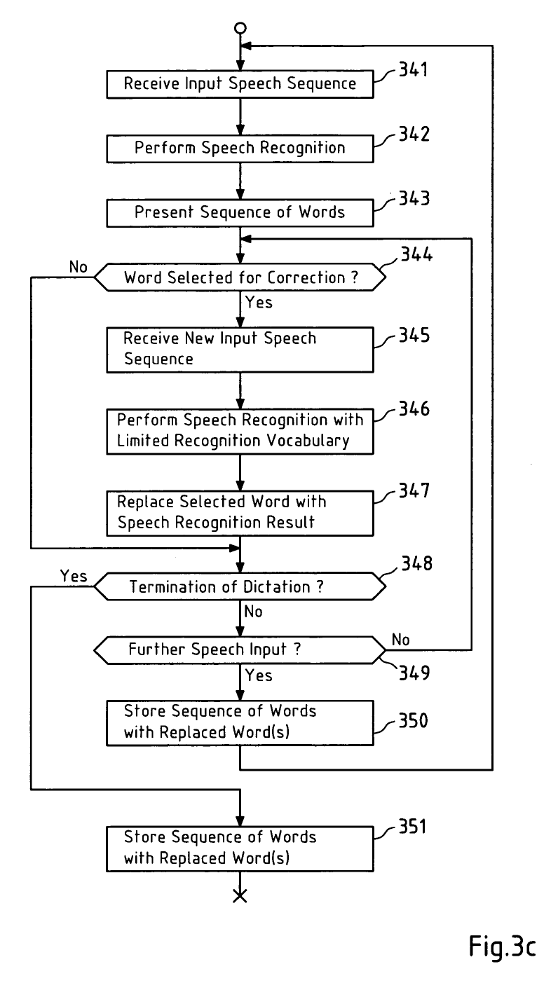

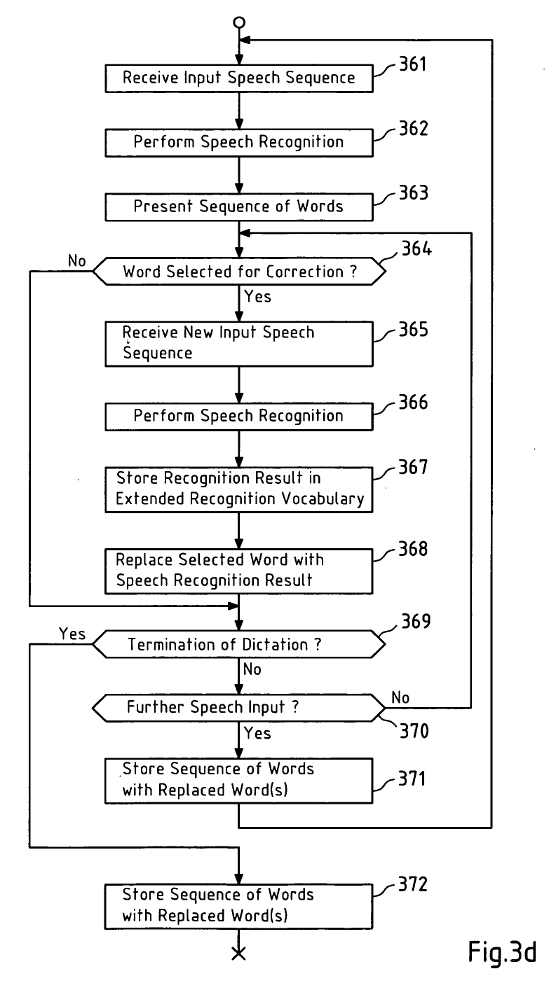

FIG. 3a depicts the method steps performed by a method for error correction in speech recognition according to the first aspect of the present invention. These steps may for instance be performed by the components of device 1 (see FIG. 1) under control of CPU 100 of device 1.

In a first step 301, an input speech sequence is received by audio I/F 102 of device 1 (see FIG. 1) either from microphone 103 or from an external input 104. Said input speech sequence may for instance represent one complete sentence spoken by a user of device 1 in a mobile dictation application. Said sentence then may be put into a message such as for instance an SMS message or an email message and transmitted to a remote receiver. In a second step 302, speech recognition is performed on said input speech sequence to obtain a sequence of words. This is performed by CPU 100 by executing speech recognition software 1012 stored in memory 101. In a third step 303, CPU 100 then determines the words in the sequence of words obtained from speech recognition that shall be emphasized during presentation, by executing application software 1011 stored in memory 101. Apparently, steps 302 and 303 thus reflect the functionality of the speech recognition unit 2a that was explained with reference to FIG. 2a above.

In a step 304, the sequence of words is then presented to a user, wherein in said presentation, the words that were destined to be emphasized in step 303 are emphasized. This presentation is triggered by CPU 100 of device 1 (see FIG. 1) and, under control of display controller 105, performed by display 106.

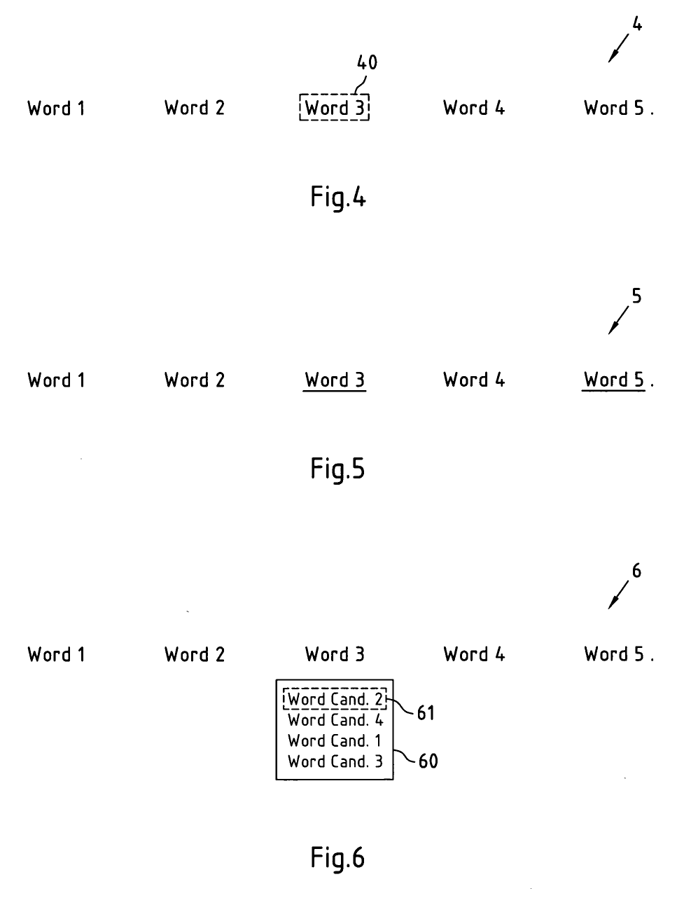

FIG. 4 depicts how such a presentation of a sequence of words 4 with one emphasized word on display 106 (see FIG. 1) could look like. The sequence of words 4 is a sentence that comprises five words, wherein the third word (Word3) is furnished with an emphasizing dashed frame 40. For this example, it was assumed that the word with the smallest recognition confidence value among all the words in the word sequence shall be emphasized in order to draw a user's attention to this potentially erroneously recognized word. Furthermore, in the example of FIG. 4, it is assumed that the dashed frame 40 is not only meant for emphasizing, but also represents a selector, which can be moved by a user in order to select words that are erroneously recognized and thus need correction. Said movement may for instance be performed word-by-word by means of a joystick or by arrow keys, and selection then may be performed by pressing a dedicated button or key (which may for instance be integrated into or implemented by said joystick itself). By automatically placing such a selector on the word with the lowest recognition confidence value (Word3 in the present example), instead of placing the selector on the first word (Word1) in said sequence of words 4, the probability that less movements of the selector are required until an erroneously recognized word can be selected is vastly reduced, and, consequently, a faster and more efficient error correction becomes possible.

FIG. 5 depicts a second example of a presentation of a sequence of words (a complete sentence) 5 with two emphasized words (Word3 and Word5). Both words are emphasized by an underline. For this example, it was assumed that all words in said sequence of words 5 that are associated with a recognition confidence value below a certain threshold shall be emphasized in order to alert a user that said emphasized words may potentially be erroneously recognized and thus may require special control. Apparently, this also speeds up error correction, because a user's focus is directed to words that have, at least among the words in said sentence, the highest probability of being erroneously recognized. In the example of FIG. 5, it is of course, in addition to the underlining, possible to place a selector on the word with the lowest recognition confidence to speed up selection of words for correction.

Returning to the flowchart of FIG. 3a, in a step 305, it is then checked by CPU 100 of device 1 (see FIG. 1) if the user has selected a word in said presented sequence of words for correction. Such a selection can for instance be performed by the user by moving a selector word-by-word over the words in said presented sequence of words and pushing a button to confirm the selection, wherein said movement and said confirmation is performed via said joystick 108 of device 1 (see FIG. 1) and signaled to CPU 100 via joystick controller 107. If CPU 100 detects that a word was selected for correction, a corrected word is determined in step 306. This may be achieved in a plurality of ways. The corrected word may be provided by a user by typing it into keypad 110, or by selecting it from a list of word candidates associated with the selected word, or by providing a new spoken representation of a correct version of said selected word. It may also be imagined that the corrected word is automatically determined by CPU 100, for instance by selecting the first word candidate from a set of word candidates that is associated with said selected word. When said corrected word has been determined, the selected word is replaced by the corrected word, i.e. the corrected word is displayed at the position of the selected word instead of the selected word.

In a step 308, CPU 100 of device 1 then checks if a user has terminated dictation, for instance by hitting a certain termination key or by saying a termination command. If this is the case, the sequence of words, including the replaced (corrected) words is stored in a step 311, for instance in memory 101 of device 1 (see FIG. 1), and the method terminates. Otherwise, CPU 100 checks in step 309 if there is further speech input, which indicates that a user wants to continue with dictation without performing further corrections. If this is the case, in a step 311, the sequence of words, including the replaced (corrected) words are stored, and the method loops back to step 301 to receive a further sequence of words (for instance a further sentence). If there is no further speech input detected in step 309, it is assumed that further error correction is desired by the user, and the method jumps back to step 305 to allow for the selection of further words for correction.

### SECOND ASPECT OF THE INVENTION

FIG. 2b schematically illustrates a block diagram illustrating the functionality of a speech recognition unit 2b with improved error correction capabilities according to a second aspect of the present invention. Therein, speech recognition core 200 of speech recognition instance 2b is implemented by CPU 100 of device 1 (see FIG. 1) by executing speech recognition software 1012 stored in memory 101, and ordering unit 204 of speech recognition unit 2b is implemented by CPU 100 by executing an application program 1011 stored in memory 101. The functionality of speech recognition core 200 of speech recognition unit 2b in FIG. 2b is the same as the functionality of speech recognition core 200 of speech recognition unit 2a in FIG. 2a, i.e. a sequence of words is determined by speech recognition of an input speech sequence, based on a language model 201 and a recognition vocabulary 202. However, speech recognition core 200 of speech recognition unit 2b (see FIG. 2b) is additionally capable of outputting, for each of the words in said sequence of words, said set of alternative word candidates that is generated during the process of speech recognition of each input speech sequence segment of said input speech sequence, or a sub-set thereof. According to the second aspect of the present invention, in ordering unit 204, the word candidates in each of said sets of word candidates are ordered (sorted) according to an ordering criterion. Said ordering criterion may be related to said recognition confidence value of each of said word candidates, or to language model 201, or to both. For instance, said word candidates in each set of word candidates may be ordered with decreasing recognition confidence values, so that the word candidates with the highest recognition confidence values appear at the beginning. Equally well, said language model may be used for ordering. For instance, in case of a bi-gram language model, word candidates in the set of word candidates that is associated with the second word in a sequence of words may be arranged according to their probability to follow the first word in said sequence of words and according to their probability to precede the third word in said sequence of words, and so on. Said ordering unit 204 then outputs the sets of word candidates containing the ordered word candidates.

Ordering unit 204 is also capable of receiving information on words that have been replaced (corrected) by a user. If said ordering criterion applied by said ordering unit 204 is (at least partially) based on said language model 201, and if said language model 201 is a bi-gram or higher level language model, any change of words in said sequence of words also may affect an ordering of word candidates in sets of word candidates, as will be explained in more detail with reference to FIG. 6 below.

FIG. 3b depicts the method steps performed by a method for error correction in speech recognition according to the second aspect of the present invention. These steps may for instance be performed by the components of device 1 (see FIG. 1) under control of CPU 100 of device 1.

In a first step 321, an input speech sequence is received via audio I/F 102 of device 1 (see FIG. 1). Speech recognition is then performed in a step 322 by CPU 100 by executing speech recognition software 1012 stored in memory 101. Subsequently, in a step 323, the word candidates in each set of word candidates associated with the words in said sequence of words as obtained from speech recognition are ordered (sorted) according to said ordering criterion. Therein, steps 322 and 323 reflect the functionality of the speech recognition unit 2b explained with reference to FIG. 2b above.

The sequence of words is then presented to the user of device 1 in a step 324 via display controller 105 and display 106. In said presentation, of course emphasizing of one or more words according to the first aspect of the present invention is possible to speed up error correction.

In a step 325, CPU 100 then checks if a word of said presented sequence of words has been selected by the user for correction (for instance by word-wise moving a selector across the words in said sequence of words and pushing a button to confirm via joystick 108). If this is the case, in a step 326, the set of word candidates that is associated with said selected word is presented to the user. A possible way to accomplish this is to present a scroll-down list containing the word candidates of the set of word candidates one below the other. As said word candidates have been ordered in step 323, the word candidate with the highest likelihood of correctly replacing said selected word appear on top of said scroll-down list, followed by the word candidate with the second highest likelihood, and so on. To select one of said word candidates, the user may then vertically move a selector in said scroll-down list and confirm his selection via a button, for instance via joystick 108.

FIG. 6 exemplarily illustrates such a scroll-down list 60 for the third word (Word3) of a sequence of words 6. The scroll-down list 60 comprises four word candidates, which have been ordered so that, with respect to the arbitrary order of said word candidates after speech recognition in step 322, which arbitrary order determines their numbering (Word Candidate 1, Word Candidate 2, Word Candidate 3, Word Candidate 4), now a different order is visible (Word Candidate 2, Word Candidate 4, Word Candidate 1, Word Candidate 3) due to the ordering performed in step 323. A selector 61 is automatically placed on the first entry in said scroll-down list 60, which can be vertically moved to selected entries from said scroll-down list 60.

Returning to the flowchart of FIG. 3b, in a step 327, CPU 100 of device 1 (see FIG. 1) checks whether a word candidate has been selected by the user. If this is the case, the selected word candidate replaces the selected (erroneously recognized) word in a step 328. If this is not the case, step 328 is skipped.

In a step 329, CPU 100 then checks if dictation shall be terminated. If this is the case, the sequence of words including the replaced word(s) is stored in a step 333, for instance in memory 101 of device 1. Otherwise, it is checked in a step 330 if there is further speech input, indicating a user's wish to continue dictation. If this is the case, the sequence of words including the replaced word(s) is stored in a step 332, for instance in memory 101 of device 1, and the method then loops back to step 321 to receive a further input speech sequence. Otherwise, optionally step 331 (given in dashed lines) may be performed, and subsequently, the method loops back to step 325 to perform corrections of further errors.

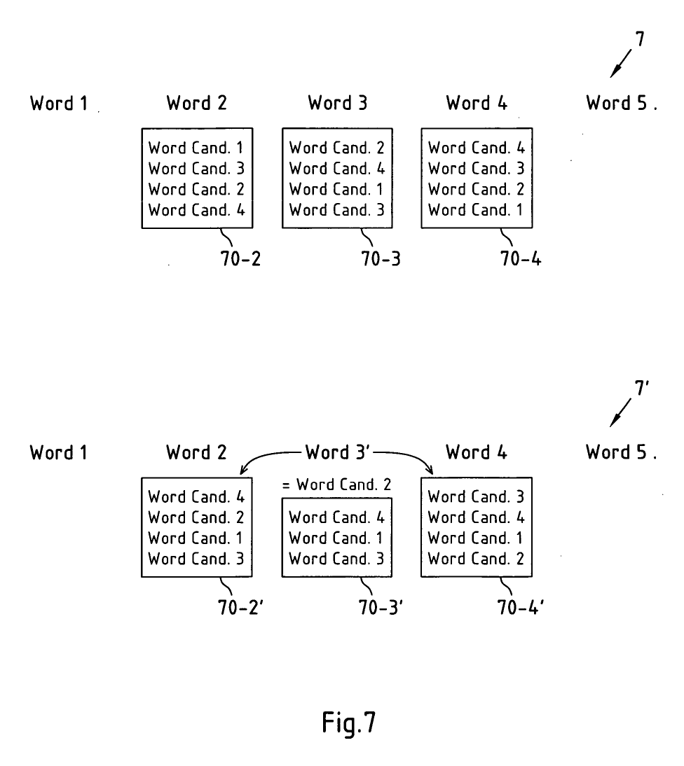

Step 331 in the flowchart of FIG. 3b is optional because it may only be of advantage if the ordering criterion that is applied in step 323 is at least partially based on a language model that considers the probability of a set of two or more words of a language to occur in a language. If this is the case, it is advantageous to update an ordering of word candidates in certain sets of word candidates after a word in said sequence of words has been replaced. This will be explained in more detail with respect to FIG. 7.

The upper part of FIG. 7 depicts a sequence of words 7, which is a complete sentence comprising five words (Word1, Word2, Word3, Word4, Word5). For the second, third and fourth word, the associated sets of word candidates 70-2, 70-3 and 70-4 are schematically illustrated as well. The word candidates in said sets of word candidates have been ordered according to an ordering criterion that at least partially depends on a bi-gram language model. For instance, a high probability that word candidate 2 in set 70-3 follows the second word (Word2), and that Word4 follows said word candidate 2 in set 70-3, predicted by a bi-gram language model, respectively, has lead to word candidate 2 in set 70-3 to be considered as most likely to correctly replace the third word (Word3).

Now, consider the case that a user selects the third word (Word3) in said sequence of words 7 to be erroneously recognized, and then selects word candidate 2 from the set of word candidates 70-3 (being associated with Word3) to replace Word3. This replacement of Word3 by word candidate 2 of set 70-3 would not have further consequences if error correction of the sequence of words 7 was finished after this correction. However, if further error corrections are required to said sequence of words 7, it has to be considered that, due to the dependence of the ordering criterion on the bi-gram language model, the order of word candidates in the sets of word candidates 70-2 and 70-4, which are respectively associated with words Word2 and Word4 that are direct neighbors of replaced Word3 in said sequence of words 7, depends on said replaced Word3. If further error corrections shall benefit from the order of word candidates to allow for a faster recognition, it is thus advisable to update the order in the set of word candidates 70-2 and 70-4. This updating is illustrated in the lower part of FIG. 7. Therein, now a sequence of words 7′ is depicted, which is basically the sequence of words 7 with Word3 being replaced by Word3′. Furthermore, the set of word candidates 70-3′ associated with Word3′ now only comprises three word candidates, as one of the original word candidates was used for replacement of Word3. Furthermore, the order of the word candidates in sets 70-2′ and 70-4′, associated with Word2 and Word4, respectively, has been updated to consider Word3′.

In the example of FIG. 7, due to the use of a bi-gram language model, which only contains statistics on two words following each other, only the sets of word candidates (70-2 and 70-4) associated with words (Word2, Word4) that are directly neighboring to the replaced word have to be updated (to obtain sets 70-2′ and 70-4′). However, if a tri-gram language model was used, also the sets of word candidates associated with Word1 and Word5 would have to be updated.

It should furthermore be noted that, from a complexity point of view, it may be advantageous to only update word candidates in sets of word candidates that are associated with words that are neighbors of replaced words and follow these replaced words (right neighbors in the example of FIG. 7), in particular if the selection of words for correction is assumed to be performed sequentially and starting with a first word in said sequence of words. The probability that error correction is desired for words that are preceding replaced words then is low, and thus for these words, no updating of the associated sets of word candidates may be required.

### THIRD ASPECT OF THE INVENTION

FIG. 2c schematically illustrates a block diagram illustrating the functionality of a speech recognition unit 2c with improved error correction capabilities according to a third aspect of the present invention. Therein, speech recognition core 200 of speech recognition instance 2c is implemented by CPU 100 of device 1 (see FIG. 1) by executing speech recognition software 1012 stored in memory 101, and recognition vocabulary selection unit 205 of speech recognition unit 2c is implemented by CPU 100 by executing an application program 1011 stored in memory 101. The functionality of speech recognition core 200 of speech recognition unit 2c in FIG. 2c is the same as the functionality of speech recognition core 200 of speech recognition unit 2b in FIG. 2b, i.e. a sequence of words is determined by speech recognition from an input speech sequence, based on a language model 201 and a recognition vocabulary 202, and, for each of the words in said sequence of words, said associated set of word candidates is output. However, speech recognition core 200 is further capable of receiving a new input speech sequence, which only contains a representation of a word spoken by the user, and to perform speech recognition on said new input speech sequence based on a restricted recognition vocabulary. Such a new input speech sequence may for instance be obtained via audio I/F 102 from microphone 103 of device 1 (see FIG. 1) in order to determine a replacement word for a word that is considered to be erroneously recognized by the user of device 1.

According to the third aspect of the present invention, speech recognition is thus first performed on a sequence-of-words level (i.e. the speech recognizer works at a continuous level and accepts an undefined number of words spoken in a continuous fashion by the user), which may for instance be a sentence level, and then, if one or more of said words are erroneously recognized, speech recognition is repeated on a word level (i.e. a level where only one word is recognized from input speech at a time). In the word-level recognition, the task of the speech recognizer is thus simplified. It knows that the user speaks only a single word, and the word boundaries are also easily detectable. Furthermore, the language model may still be applied by taking into account words that were already recognized in sentence-level speech recognition.

In prior art, usually a default recognition vocabulary is used even for the word-level recognition. This may help in cases when rare words that are acoustically similar to some more frequent ones are misrecognized (for instance “solely” vs. “only”). This is due to the fact that proper language modeling for rare words is usually difficult.

In contrast, according to the third aspect of the present invention, a restricted recognition vocabulary is used for word-level recognition of the new input speech sequence, which comprises a spoken representation of a correct version of a selected (erroneously recognized) word from said sequence of words, and this restricted recognition vocabulary is the set of word candidates that was generated by the speech recognition core 200 for said selected word during the speech recognition of the input speech sequence. This restricted recognition vocabulary is generally much smaller than the default recognition vocabulary 202. Using such a reduced recognition vocabulary is particularly advantageous in cases where there are (small) differences acoustically between the word candidates, but from a language modeling point of view, they are identical. For instance, “Johnny” can be misrecognized as “John”, because both alternatives are given names that have an equal possibility of occurrence with respect to neighboring words. Also, a small recognition vocabulary makes speech recognition faster and more reliable.

The proper selection of the correct recognition vocabulary is performed by recognition vocabulary selection unit 205, which either selects the (standard) recognition vocabulary 202 (for the input speech sequence), or the set of word candidates associated with the selected word (for the new input speech sequence containing a spoken representation of a correct version of said selected word). The output of recognition vocabulary selection unit 205 is then made available to speech recognition core 200.

FIG. 3c depicts the method steps performed by a method for error correction in speech recognition according to the third aspect of the present invention. These steps may for instance be performed by the components of device 1 (see FIG. 1) under control of CPU 100 of device 1.

In a first step 341, an (initial) input speech sequence is received via audio I/F 102, and then speech recognition is performed in step 342 to obtain the sequence of words (e.g. a complete sentence) that is represented by said input speech sequence. This speech recognition is based on a default recognition vocabulary (see recognition vocabulary 202 in FIG. 2c), wherein the selection of this speech recognition vocabulary is controlled by the recognition vocabulary selection unit 205 (see FIG. 2c). As already stated above, both speech recognition and recognition vocabulary selection are implemented by the CPU 100 of device 1 (see FIG. 1) by executing speech recognition software 1012 and an application program 1011, respectively.

The outcome of speech recognition then is presented to the user via display controller 105 and display 106 (see FIG. 1) in a step 343. In said presentation, of course emphasizing of one or more words according to the first aspect of the present invention is possible to speed up error correction.

CPU 100 then checks in step 344 if one of said words in said presented sequence of words has been selected by the user for correction (for instance by moving a selector on this word by joystick 108 and confirming). If this is the case, a new input speech sequence is received in a step 345. This may for instance be accomplished by recording said new input speech sequence by microphone 103 and feeding the recorded sequence to CPU 100 via audio I/F 102. Said new input speech sequence only contains a spoken representation of a correct version of the word that has been selected by the user for correction in step 344. Based on this new input speech sequence, speech recognition is performed in step 346. Therein, under the control of CPU 100 executing an application program 1011 (see FIG. 1), the set of word candidates associated with the selected word is used as restricted recognition vocabulary to make speech recognition faster and more exact. The outcome of the speech recognition then replaces the selected word in step 347.

In step 348, CPU 100 checks if the user wants to terminate dictation. If this is the case, the sequence of words including the replaced word(s) is stored in step 351, and the method terminates. Otherwise, CPU 100 checks if there is further speech input in a step 349. If this is the case, the sequence of words including the replaced word(s) is stored, and the method returns to step 341 to allow reception of further input speech sequences. Otherwise, the method jumps to step 344 to allow for the correction of further errors in said sequence of words.

### FOURTH ASPECT OF THE INVENTION

FIG. 2d schematically illustrates a block diagram illustrating the functionality of a speech recognition unit 2d with improved error correction capabilities according to a fourth aspect of the present invention. Therein, extended speech recognition core 200′, which now further includes speech recognition for letters, of speech recognition instance 2d is implemented by CPU 100 of device 1 (see FIG. 1) by executing speech recognition software 1012 stored in memory 101.

According to the fourth aspect of the present invention, extended speech recognition core 200′ is capable of performing speech recognition on an input speech sequence to obtain a sequence of words that is represented by said input speech sequence, and of performing speech recognition on a new input speech sequence that contains both a spoken representation of a word and a spelled representation thereof in order to obtain a corrected word. Said word being represented by said new input speech sequence is a correct version of an erroneously recognized word that is selected by a user for correction. This speech recognition is based on a language model 201, and on an extended recognition vocabulary 202′, which may particularly comprise letters required by extended speech recognition core 200′ for letter detection (these letters may however be already contained in a default recognition vocabulary). Extended speech recognition core 200′ then can use the new input speech sequence, comprising a spoken representation of a word and its spelled representation only, as for instance “Memphis, M E M P H I S” to obtain a more accurate speech recognition result as compared to the case where said input speech sequence represents a plurality of words (like a sentence).

Even though letter recognition as such may be quite challenging for some languages (e.g. the English E-set), exploiting spelling provides a good way for correcting errors in, e.g. proper names. Some person or city names may be missing from the speech recognizer's vocabulary, and in these cases, an acoustically similar word would always get recognized. E.g. “Newport” may get misrecognized as “New York” (handled as one word in the recognition vocabulary). In this case, “N E W P 0 R T” would be clearly distinguishable from “N E W Y 0 R K”.

Furthermore, words recognized by extended speech recognition core 200′ by analyzing a spoken and spelled representation of a word may then be stored in the extended recognition vocabulary 202′, as indicated by the bi-directional array between box 200′ and box 202′ in FIG. 2d.

FIG. 3d depicts the method steps performed by a method for error correction in speech recognition according to the fourth aspect of the present invention. These steps may for instance be performed by the components of device 1 (see FIG. 1) under control of CPU 100 of device 1.

In a first step, an (initial) input speech sequence is received via audio I/F 102 of device 1 (see FIG. 1). In step 362, then speech recognition is performed on this input speech sequence to obtain a sequence of words represented by said input speech sequence. Said sequence of words may for instance be a complete sentence. Said sequence of words is then, in a step 363, presented to a user via display controller 105 and display 106 of device 1. In said presentation, of course emphasizing of one ore more words according to the first aspect of the present invention is possible to speed up error correction.

CPU 100 then checks in step 364 if one of said words has been selected by a user for correction (for instance by moving a selector to said word via joystick 108). If a word has been selected for correction, a new input speech sequence, only containing a spoken representation of a correct version of said selected word and a spelled representation of said correct version of said selected word, is received in step 365. This new input speech sequence may be spoken by the user into microphone 103 and forwarded to CPU 100 via audio I/F 102. In step 366, speech recognition is performed on the new input speech sequence, i.e. on both the spoken representation and the spelled representation of the correct version of said word selected in step 364. The results of both recognitions, for instance a plurality of possible recognition results for the word and a plurality of letter sets for its spelling, are then jointly analyzed to come to a final recognition result, i.e. the corrected word. In step 367, this recognition result is stored in the extended recognition vocabulary 202′ (see FIG. 2d), for instance as mapping between phonemes and text or similar. In step 368, the word selected in step 364 is then replaced by the corrected word as determined in step 366.

In step 369, CPU 100 checks if the user wants to terminate dictation. If this is the case, the sequence of words including the replaced word(s) is stored in step 372, and the method terminates. Otherwise, CPU 100 checks if there is further speech input in a step 370. If this is the case, the sequence of words including the replaced word(s) is stored, and the method returns to step 361 to allow reception of further input speech sequences. Otherwise, the method jumps to step 364 to allow for the correction of further errors in said sequence of words.

The invention has been described above by means of exemplary embodiments. It should be noted that there are alternative ways and variations which will be evident to any person skilled in the art and can be implemented without deviating from the scope and spirit of the appended claims. In particular, the present invention is not limited to deployment in the context of mobile dictation. It may equally well be used to improve the speed and ease the way a user interacts with a device in desktop applications (for instance for dictation of texts into a desktop computer). Furthermore, the present invention is not limited to devices that comprise a display for presentation of the recognition results. This presentation may equally well be performed acoustically, for instance in applications for visually impaired persons. Instead of selecting words and word candidates by a joystick, it may equally well be envisaged to assign each selection alternative a number, and to allow a user to select by entering the corresponding number via a keyboard, or by simply saying the number. It should also be noted that, although the four aspects of the present invention were presented separately, it is possible to combine some of them (for instance the first aspect with the second, third and fourth aspect, respectively) to achieve optimally improved error correction in speech recognition.

1. A method for correcting words in a sequence of words that is obtained from speech recognition of an input speech sequence, said method comprising:
presenting said sequence of words to a user, wherein each word in said sequence of words is associated with a respective recognition confidence value, and wherein at least one word in said sequence of words is automatically emphasized in dependence on its recognition confidence value; and
replacing at least one word in said sequence of words, in case it has been selected by a user for correction.

2. The method according to claim 1, wherein said at least one emphasized word is associated with a lowest recognition confidence value of all words in said sequence of words.

3. The method according to claim 2, wherein said at least one emphasized word is automatically emphasized by automatically positioning a selector on it.

4. The method according to claim 1, wherein said at least one emphasized word is associated with a recognition confidence value that is below a pre-defined threshold.

5. A device for correcting words in a sequence of words that is obtained from speech recognition of an input speech sequence, said device comprising:
means arranged for presenting said sequence of words to a user, wherein each word in said sequence of words is associated with a respective recognition confidence value, and wherein at least one word in said sequence of words is automatically emphasized in dependence on its recognition confidence value; and
means arranged for replacing at least one word in said sequence of words, in case it has been selected by a user for correction.

6. The device according to claim 5, wherein said device is a portable multimedia device or a part thereof.

7. A software application product, comprising a storage medium having a software application for correcting words in a sequence of words that is obtained from speech recognition of an input speech sequence embodied therein, said software application comprising:
program code for presenting said sequence of words to a user, wherein each word in said sequence of words is associated with a respective recognition confidence value, and wherein at least one word in said sequence of words is automatically emphasized in dependence on its recognition confidence value; and
program code for replacing at least one word in said sequence of words, in case it has been selected by a user for correction.

8. A method for correcting words in a sequence of words that is obtained from speech recognition of an input speech sequence, wherein for each word in said sequence of words, an associated set of alternative word candidates exists, said method comprising:
presenting said sequence of words to a user; and
replacing at least one word in said sequence of words, in case it has been selected by said user for correction, by a word candidate from its associated set of word candidates, wherein said word candidates in said set of word candidates that is associated with said at least one selected word are ordered according to an ordering criterion related to a likelihood of said word candidates to correctly replace said at least one selected word.

9. The method according to claim 8, wherein said ordering criterion is based on at least one of a language model that contains statistics on the likelihood of a set of words comprising at least one word to occur in a language, and a recognition confidence of said word candidates, wherein said recognition confidence expresses, for each word candidate in a set of word candidates, a respective confidence that said word candidate is a correct speech recognition result.

10. The method according to claim 8, wherein a selecting of said word candidate that replaces said at least one selected word from said set of word candidates comprises stepping through said word candidates on a word-candidate-by-word-candidate basis.

11. The method according to claim 8, wherein said ordering criterion is at least based on a language model that contains statistics on the likelihood of at least two words of a language following each other, said method further comprising:
updating, in case said at least one word has been selected and replaced in said sequence of words by said word candidate, an order of word candidates in at least one set of word candidates associated with a respective word that is, within said sequence of words, adjacent to said at least one selected and replaced word, wherein said updating of said order of said word candidates in said at least one set of word candidates is performed according to said ordering criterion and under consideration of said word candidate by which said at least one selected and replaced word has been replaced.

12. A device for correcting words in a sequence of words that is obtained from speech recognition of an input speech sequence, wherein for each word in said sequence of words, an associated set of alternative word candidates exists, said device comprising:
means arranged for presenting said sequence of words to a user; and
means arranged for replacing at least one word in said sequence of words, in case it has been selected by said user for correction, by a word candidate from its associated set of word candidates, wherein said word candidates in said set of word candidates that is associated with said at least one selected word are ordered according to an ordering criterion related to a likelihood of said word candidates to correctly replace said at least one selected word.

13. The device according to claim 12, further comprising:
means arranged for stepping through selection alternatives on a word-candidate-by-word-candidate basis in order to select said word candidate that replaces said at least one selected word from said set of word candidates.

14. The device according to claim 12, further comprising:
means arranged for updating, in case said at least one word has been selected and replaced in said sequence of words by said word candidate, an order of word candidates in at least one set of word candidates associated with a respective word that is, within said sequence of words, adjacent to said at least one selected and replaced word, wherein said ordering criterion is at least based on a language model that contains statistics on a likelihood of at least two words of a language following each other, and wherein said updating of said order of said word candidates in said at least one set of word candidates is performed according to said ordering criterion and under consideration of said word candidate by which said at least one selected and replaced word has been replaced.

15. The device according to claim 12, wherein said device is a portable multimedia device or a part thereof.

16. A software application product, comprising a storage medium having a software application embodied therein for correcting words in a sequence of words that is obtained from speech recognition of an input speech sequence, wherein for each word in said sequence of words, an associated set of alternative word candidates exists, said software application comprising:
program code for presenting said sequence of words to a user; and
program code for replacing at least one word in said sequence of words, in case it has been selected by said user for correction, by a word candidate from its associated set of word candidates, wherein said word candidates in said set of word candidates that is associated with said at least one selected word are ordered according to an ordering criterion related to a likelihood of said word candidates to correctly replace said at least one selected word.

17. The software application product according to claim 16, wherein said ordering criterion is at least based on a language model that contains statistics on a likelihood of at least two words of a language following each other, said software application product further comprising:
program code for updating, in case said at least one word has been selected and replaced in said sequence of words by said word candidate, an order of word candidates in at least one set of word candidates associated with a respective word that is, within said sequence of words, adjacent to said at least one selected and replaced word, wherein said updating of said order of said word candidates in said at least one set of word candidates is performed according to said ordering criterion and under consideration of said word candidate by which said at least one selected and replaced word has been replaced.

18. A method for correcting words in a sequence of words that is obtained from speech recognition of an input speech sequence, wherein for each word in said sequence of words, an associated set of alternative word candidates exists, said method comprising:
presenting said sequence of words to a user; and
replacing at least one word in said sequence of words, in case it has been selected by said user for correction, by a word that is obtained from speech recognition of an new input speech sequence that only contains a representation of a correct version of said at least one selected word spoken by said user, wherein a recognition vocabulary used in said speech recognition of said new input speech sequence is limited to said set of word candidates associated with said at least one selected word.

19. A device for correcting words in a sequence of words that is obtained from speech recognition of an input speech sequence, wherein for each word in said sequence of words, an associated set of alternative word candidates exists, said device comprising:
means arranged for presenting said sequence of words to a user; and
means arranged for replacing at least one word in said sequence of words, in case it has been selected by said user for correction, by a word that is obtained from speech recognition of a new input speech sequence that only contains a representation of a correct version of said at least one selected word spoken by said user, wherein a recognition vocabulary used in said speech recognition of said new input speech sequence is limited to said set of word candidates associated with said at least one selected word.

20. The device according to claim 19, wherein said device is a portable multimedia device or a part thereof.

21. A software application product, comprising a storage medium having a software application embodied therein for correcting words in a sequence of words that is obtained from speech recognition of an input speech sequence, wherein for each word in said sequence of words, an associated set of alternative word candidates exists, said software application comprising:
program code for presenting said sequence of words to a user; and
program code for replacing at least one word in said sequence of words, in case it has been selected by said user for correction, by a word that is obtained from speech recognition of a new input speech sequence that only contains a representation of a correct version of said at least one selected word spoken by said user, wherein a recognition vocabulary used in said speech recognition of said new input speech sequence is limited to said set of word candidates associated with said at least one selected word.

22. A method for correcting words in a sequence of words that is obtained from speech recognition of an input speech sequence, said method comprising:
presenting said sequence of words to a user; and
replacing at least one word in said sequence of words, in case it has been selected by said user for correction, by a word that is obtained from a new input speech sequence, which only contains a representation of a correct version of said at least one selected word spoken by said user and a representation of said correct version of said at least one selected word spelled by said user.

23. A device for correcting words in a sequence of words that is obtained from speech recognition of an input speech sequence, said device comprising:
means arranged for presenting said sequence of words to a user; and
means arranged for replacing at least one word in said sequence of words, in case it has been selected by said user for correction, by a word that is obtained from a new input speech sequence, which only contains a representation of a correct version of said at least one selected word spoken by said user and a representation of said correct version of said at least one selected word spelled by said user.

24. The device according to claim 23, wherein said device is a portable multimedia device or a part thereof.

25. A software application product, comprising a storage medium having a software application embodied therein for correcting words in a sequence of words that is obtained from speech recognition of an input speech sequence, said software application comprising:
program code for presenting said sequence of words to a user; and
program code for replacing at least one word in said sequence of words, in case it has been selected by said user for correction, by a word that is obtained from a new input speech sequence, which only contains a representation of a correct version of said at least one selected word spoken by said user and a representation of said correct version of said at least one selected word spelled by said user.
